(19) United States
(12) Patent Application Publication
(10) Pub. No.: US 2014/0172401 A1
(43) Pub. Date: Jun. 19, 2014

(54) METHOD OF SIMULATING DISCRETE EVENT

(71) Applicants: Kun Chul HWANG, Gyeongsangnam-do (KR); Min Kyu LEE, Gyeongsangnam-do (KR)

(72) Inventors: Kun Chul HWANG, Gyeongsangnam-do (KR); Min Kyu LEE, Gyeongsangnam-do (KR)

(73) Assignee: AGENCY FOR DEFENSE DEVELOPMENT, Daejeon (KR)

(21) Appl. No.: 13/930,263

(22) Filed: Jun. 28, 2013

(30) Foreign Application Priority Data
Dec. 17, 2012 (KR) 1020120147689

(51) Int. Cl. G06F 17/50

(52) U.S. Cl. CPC G06F 17/5009
USPC 703/18

(57) ABSTRACT

Disclosed is a discrete event simulation method using Matlap object-oriented programming (OOP). The method of simulating a discrete event comprising a plurality of models and a root coordinator, comprises: the root coordinator's managing time schedules of the models; the root coordinator's calling a model function based on the time schedules; and the models' transmitting external input events to each other when the model function is called, based on a coupling structure of the models, wherein when the plurality of models transmit the external input events to each other, the external input events are transmitted as an input parameter of the model function.

### CROSS-REFERENCE TO RELATED APPLICATION

Pursuant to 35 U.S.C. §119(a), this application claims the benefit of earlier filing date and right of priority to Korean Application No. 10-2012-0147689, filed on Dec. 17, 2012, the contents of which is incorporated by reference herein in its entirety.

### BACKGROUND OF THE DISCLOSURE

1. Field of the Disclosure

The present disclosure relates to a method of simulating a discrete event, and particularly, to a discrete event simulation method using Matlap object-oriented programming (OOP)

2. Background of the Disclosure

A simulation framework indicates a software provided to develop simulation application programs, which consists of various types of tool boxes for supporting and analyzing development of other application programs, such as various types of recyclable libraries, a class API (Application Programming Interface) for development of models, a statistics analysis tool and a visualization tool.

Unlike a simple program library for supporting development of software, the simulation framework determines a principle to simulate application programs (time management function), and a model structure (data management function). Therefore, the simulation framework is called a ‘simulation engine’ or a ‘simulation development environment’ in the aspect of managing a core function of a simulation.

Generally, such simulation framework is provided to a developer in the form of a commercial and non-commercial package software. According to a level, the simulation framework is categorized into a library type, and an integrated development environment (IDE) type where models can be implemented, simulated and analyzed on a single completed user interface screen.

The simulation framework largely includes DEVSim++ of a library type, and Modelica, Matlab/Simulink, Arena, AnyLogic, etc. of an integrated development environment type.

The Matlab/Simulink is a model-based simulation and system programming tool for supporting a convenient script-based programming environment and a convenient block diagram-based graphic modeling technique, and has recorded a market share more than 55% in a simulation market in the field of technical computing, dynamics analysis and signal processing. Further, the Matlab/Simulink obtains a wide range of users in the field of aeronautics and national defense.

The Matlab/Simulink has an advantage that a simulation environment is provided in a rapid and convenient manner, in a single subsystem represented as a formula such as differential equations, and in a modeling of a component unit. However, the Matlab/Simulink has many restrictions on developing a system simulation of a higher level where a plurality of objects (instances) participate, because it does not provide a programming technique and tool with respect to assembling and operating object-oriented simulation models.

### SUMMARY OF THE DISCLOSURE

Therefore, an aspect of the detailed description is to provide a simulation framework capable of effectively reflecting, to Matlap programming, characteristics required from a simulation of a system level, i.e., an assembly characteristic of a system consisting of a plurality of subsystems such as an initial-driving unit, a detecting unit and a controller, and a function to process various events occurring when the system operates.

To achieve these and other advantages and in accordance with the purpose of this specification, as embodied and broadly described herein, there is provided a method of simulating a discrete event comprising a plurality of models and a root coordinator, the method comprising: the root coordinator's managing time schedules of the models; the root coordinator's calling a model function based on the time schedules; and the models' transmitting external input events to each other when the model function is called, based on a coupling structure of the models, wherein when the plurality of models transmit the external input events to each other, the external input events are transmitted as an input parameter of the model function.

According to an embodiment, the step of the root coordinator's managing time schedules of the models may comprise: the root coordinator's collecting time schedules of the plurality of models; and the root coordinator's setting a minimum value of the collected time schedules, as a next time schedule.

According to an embodiment, the plurality of models may comprise atomic models and coupled models.

According to an embodiment, the root coordinator may be a single simulator with respect to the atomic models and the coupled models.

According to an embodiment, the method may further comprise implementing a structure of the coupled models, as a composite pattern.

According to an embodiment, the method may further comprise directly transmitting messages among the plurality of models.

Further scope of applicability of the present application will become more apparent from the detailed description given hereinafter. However, it should be understood that the detailed description and specific examples, while indicating preferred embodiments of the disclosure, are given by way of illustration only, since various changes and modifications within the spirit and scope of the disclosure will become apparent to those skilled in the art from the detailed description.

### BRIEF DESCRIPTION OF THE DRAWINGS

The accompanying drawings, which are included to provide a further understanding of the disclosure and are incorporated in and constitute a part of this specification, illustrate exemplary embodiments and together with the description serve to explain the principles of the disclosure.

In the drawings:

FIG. 1 is a conceptual view showing models of DEVS formalism and a simulation structure;

FIG. 2 is a conceptual view showing a hierarchical structure of discrete event simulation (DEVS) models implemented as coupled models;

FIG. 3 is a conceptual view showing the principle of an operation of discrete event simulation (DEVS) models implemented as atomic models;

FIGS. 4A and 4B are conceptual views showing internal and external processing orders of a DEVS algorithm;

FIGS. 5A and 5B are conceptual views showing a model hierarchy diagram of a simulation framework before and after the present invention is applied thereto;

FIGS. 6A and 6B are conceptual views showing message transmission methods of a simulation framework before and after the present invention is applied thereto;

FIG. 7 is a conceptual view showing a simulation algorithm of a simulation framework after the present invention is applied thereto;

FIG. 8 is a conceptual view showing a model structure visualization function after the present invention is applied thereto;

FIG. 9 is a conceptual view showing a coupling relation of models and a simulation visualization after the present invention is applied thereto;

FIG. 10 is a conceptual view showing a function to visualize a schedule with respect to run time events of model objects, after the present invention is applied thereto;

FIG. 11 is a conceptual view showing a simulation log analysis function; and

FIG. 12 is a conceptual view showing a simulation log visualization function.

### DETAILED DESCRIPTION OF THE DISCLOSURE

Description will now be given in detail of the exemplary embodiments, with reference to the accompanying drawings. For the sake of brief description with reference to the drawings, the same or equivalent components will be provided with the same reference numbers, and description thereof will not be repeated.

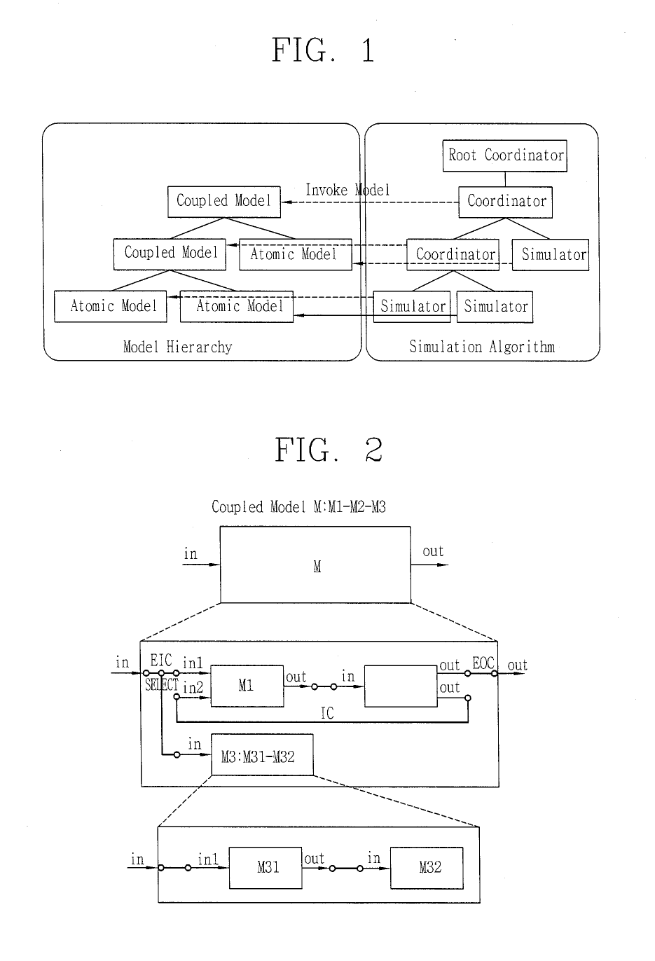

FIG. 1 is a conceptual view showing models of DEVS formalism and a simulation structure.

The Discrete Event Simulation (DEVS) formalism indicates a modeling theory proposed based on a function theory and a system theory, which is a sort of standardization tool serving as a Unified Modeling Language (UML) and a design pattern in developing simulation programs.

The DEVS model represented as a DEVS diagram has a very similar specification to the UML, because both of the DEVS and the UML are based on an object-oriented paradigm. However, the DEVS reflects a simulation time managing function which cannot be implemented by the UML, to the specification, and provides a simulation control algorithm differentiated from a hierarchical model structure as a design pattern specialized for a simulation.

A DEVS framework is a software which supports such DEVS formalism for actual application to development of simulation programs, which provides various types of Application Programming Interfaces (APIs) capable of implementing, simulating and analyzing models according to DEVS formalism. Representative examples of the APIs include DEVSim++ developed in C++ language, and DEVSJAVA developed in JAVA lanaguage.

FIG. 1 shows a hierarchical simulation model structure provided from DEVS formalism, and a simulation algorithm for scheduling orders to simulate models.

More specifically, a model structure of the DEVS is a tree structure shown in FIG. 1, a hierarchical structure to atomic models and coupled models.

The formula on the atomic models is as follows.

Atomic Model=<X,Y,S,δext,δint,λ,ta> [FORMULA 1]

Here, ‘X’ denotes a set of input events, ‘Y’ denotes a set of output events, “S’ denotes a set of internal states of models, and ‘δext’ denotes an external transition function (Q×X→S). ‘λ’ denotes an output function (S→Y), ‘δint’ denotes an internal transition function (S→S), and ‘ta’ denotes a time advance function (S→R0,∞).

The formula on the ‘Q’ is as follows.

Q={(s,e)|sεS,0≦e≦ta(s)} [FORMULA 2]

Here, ‘s’ denotes a current state, ‘e’ denotes a time duration for which the atomic models stay in the current state, and ‘Q’ denotes a set of total states of atomic models.

The formula on the coupled models is as follows.

Coupled Model=<X,Y,M,EIC,EOC,IC,SELECT> [FORMULA 3]

Here, ‘X’ denotes a set of input events, ‘Y’ denotes a set of output events, ‘M’ denotes a set of lower models, ‘EIC’ (External Input Coupling Relation) denotes a coupling relation of external input events, and ‘EOC’ (External Output Coupling Relation) denotes a coupling relation of external output events. ‘IC’ (Internal Coupling Relation) denotes a coupling relation of internal events, and ‘SELECT’ denotes a priority selection function among internal models with respect to process of external input events.

The above atomic models and coupled models show a structure and an operation of programs which should be absolutely described in a simulation program. The coupled models show a model structure in DEVS scheme. That is, the coupled models mean a system model implemented as an assembly of subsystem models in DEVS scheme.

FIG. 2 is a conceptual view showing a hierarchical structure of DEVS models implemented as coupled models.

As shown in FIG. 2, a single system is represented as coupled models in DEVS scheme. FIG. 2 shows that a single system is implemented as a set of a is plurality of hierarchical subsystems, in which a data structure of a system model is determined by a coupling structure of subsystems.

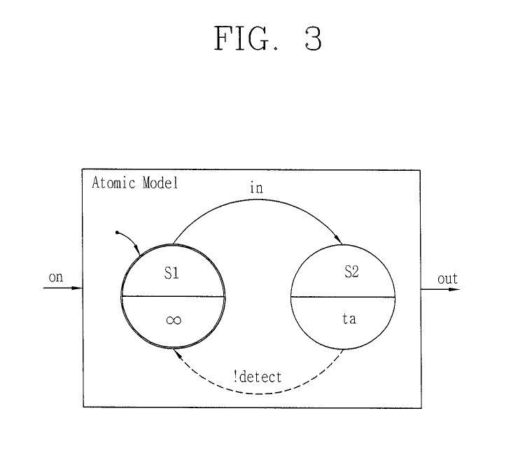

FIG. 3 is a conceptual view showing the principle of an operation of DEVS models implemented as atomic models.

In DEVS scheme, an operation of models is described only through atomic models. FIG. 3 shows a Timed Finite State Machine, which explains about two operating causes of atomic models. As shown in FIG. 3, in DEVS scheme, the operating causes of the atomic models are defined as an External Event indicated by the solid line, and a Timed Event indicated by the dotted line.

Referring to FIG. 3, the atomic models have two states of S1 and S2, and the initial state starts from S1. In DEVS scheme, there exists a resident time for which the atomic models can stay in a single state, which is represented as a time value (ta: time advance) at the lower end of a semi-circle. Upon receipt of an external event, the atomic models call an external transition function to thus define a corresponding operation. If a resident time defined in a single state exceeds, the atomic models call an internal transition function to thus define a corresponding operation.

Referring to FIG. 3, when an external event is received, the model state changes from S1 to S2 based on the external transition function. If the time (ta) exceeds in S2, an output event (detect) is generated and the model state changes from S2 to S1.

In DEVS formalism, models are simulated in synchronization with an internally scheduled operation time, together with an externally input event. That is, in a DEVS algorithm, an external transition function of models is called according to an external input event, and an output function and an internal transition function of models are called according to an internal scheduling event (time event).

For implementation of DEVS models, simulation processors are generally required. The simulation processors are configured to process the DEVS algorithm. Also, the simulation processors are configured to correspond to the respective models (constitutive models) in a ratio of 1:1 (refer to FIG. 1).

The simulation processor is referred to as a ‘simulator’ with respect to atomic models, and as a ‘coordinator’ with respect to coupled models. The simulation processor calls a function of models in synchronization with an operation time, sets a next operation time of the models, and then propagates the set next operation time to an upper processor.

The uppermost coordinator, ‘Root Coordinator’ collects time schedules which have propagated from the lower models, and sets a minimum vale among the collected time schedules as a next schedule time.

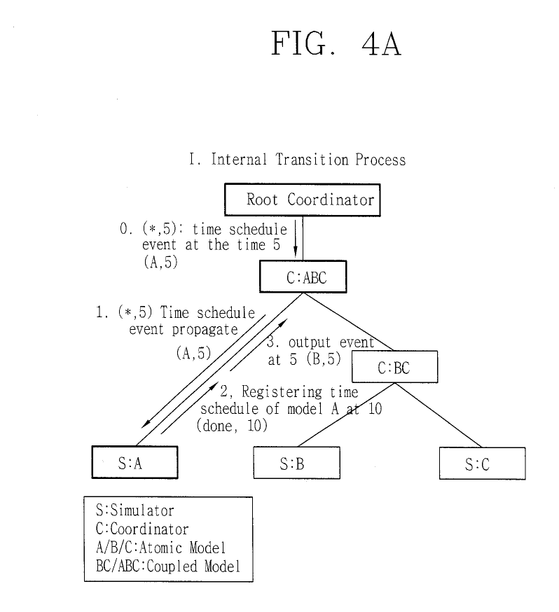

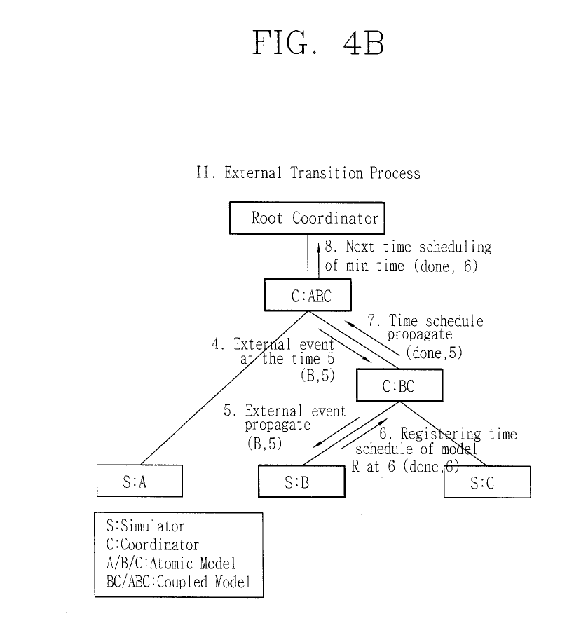

FIGS. 4A and 4B are conceptual views showing internal and external processing orders of a DEVS algorithm.

FIGS. 4A and 4B show processing orders of a DEVS algorithm in synchronization with a function call.

The DEVS formalism is based on an object-oriented paradigm. Therefore, It was difficult to actually apply the DEVS formalism to Matlap versions prior to 2007 having a procedure-oriented programming characteristic. However, since the subsequent versions to 2007, object-oriented programming has been supported. This could provide a probability to develop a Matlap-based DEVS framework.

The following tables 1 and 2 show analysis results on structures of a new DEVS framework and the existing framework.

TABLE 1

| Framework | Advantages |
|---|---|
| DEVSim++ | A DEVS function can be configured in |
| | an intuitional and simple manner, and a |
| | simulation can be controlled and |
| | analyzed. |
| DEVSJAVA | Models can be visually displayed and |
| | configured. |

TABLE 2

| | |
|---|---|
| Implementing Formalism | Utilizable Design Pattern |
| Configuring Hierarchical Models | Composite Pattern |
| Connecting Coupled Models | Observer/Command/Strategy Pattern |
| Executing Atomic Models | State Pattern |

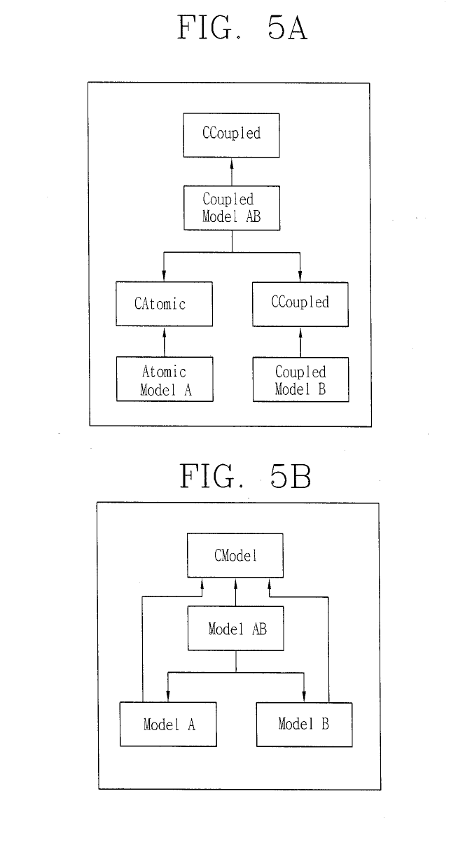

FIGS. 5A and 5B are conceptual views showing a model hierarchy diagram of a simulation framework. More specifically, FIG. 5A shows a model hierarchy diagram of a simulation framework before the present invention is applied thereto, and FIG. 5B shows a model hierarchy diagram of a simulation framework after the present invention is applied thereto.

A new framework is being developed for the purpose of simplicity. As analysis results on a structure of the existing framework and an applicable design pattern, a structure of coupled models was implemented as a composite pattern. This could allow a coupled class to be omitted in the existing framework.

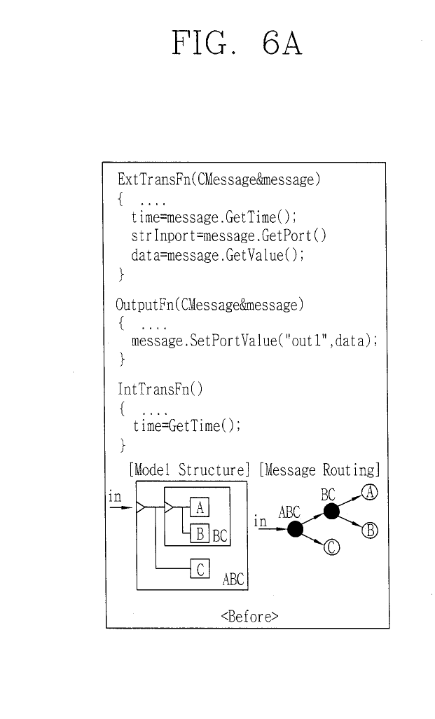

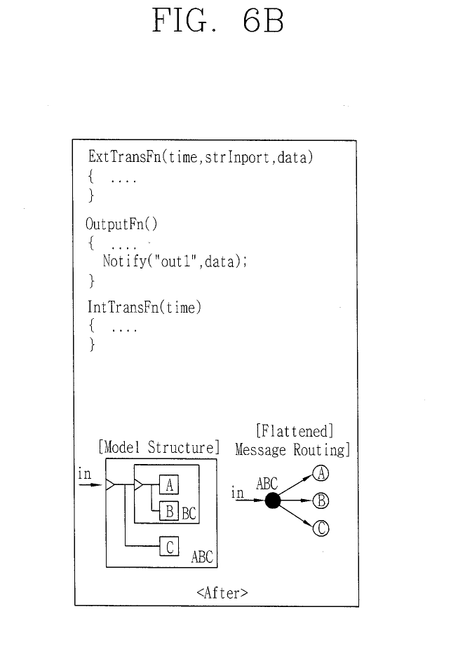

FIGS. 6A and 6B are conceptual views showing message transmission methods of a simulation framework. More specifically, FIG. 6A shows a message transmission method of a simulation framework before the present invention is applied thereto, and FIG. 6B shows a message transmission method of a simulation framework after the present invention is applied thereto.

In the present invention, when calling a model function, event information was directly transmitted (delivered) as an input parameter of a function, by replacing an event transmission structure and a simulation information acquisition structure through a message class in the existing framework. Further, the existing message transmission method to transmit a message to a message tree due to a hierarchical model structure, was simplified so that a flattening technique for removing a message tree internally could be applied thereto.

Referring to FIGS. 6A and 6B, a function name shows a basic interface provided in a model class for implementing models. FIG. 6A shows an atomic model class of DEVSim++, a comparative object of a framework to be developed, and FIG. 6B shows an interface of an atomic model class of a developed framework.

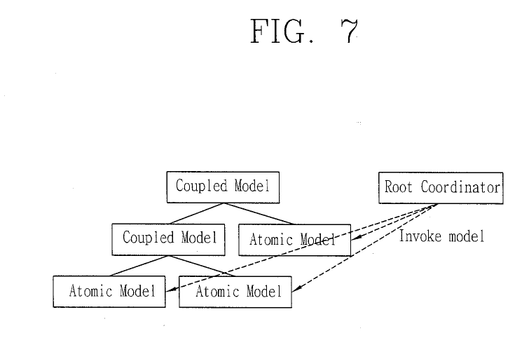

FIG. 7 is a conceptual view showing a simulation algorithm of a simulation framework after the present invention is applied thereto.

In the existing simulation algorithm, simulators are provided for atomic models and coupled models in a ratio of 1:1. On the contrary, in the present invention, only a single simulator called ‘Root Coordinator’ is provided for the total models.

In the present invention, it is configured to propagate external input events by the respective models based on a coupling structure therebetween, but to manage time schedules with respect to all the atomic models by the Root Coordinator. Under such configuration, the same results as the existing event scheduling technique are obtained.

However, such simplicity merely corresponds to an internal change of a class API, a grammar and a utilization technique of the framework was similar to the existing simulation algorithm (DEVSim++). Consequently, the new framework was simplified so that base classes to be substantially considered could be two classes (Simulator and Model classes), while implementing the function of DEVS formalism like in the conventional art. Furthermore, a model viewer class for model visualization is provided in a Matlab DEVS framework as a core.

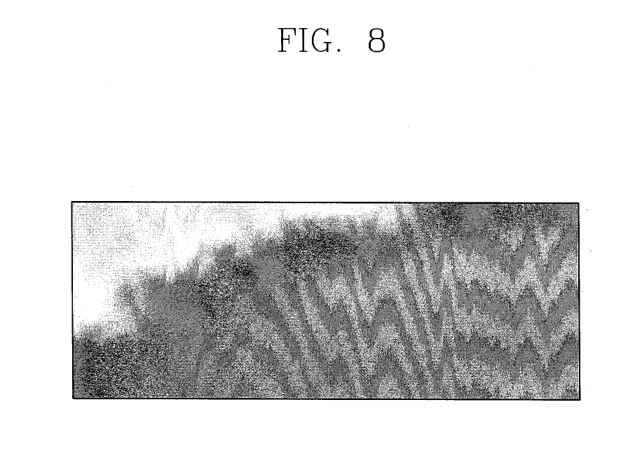

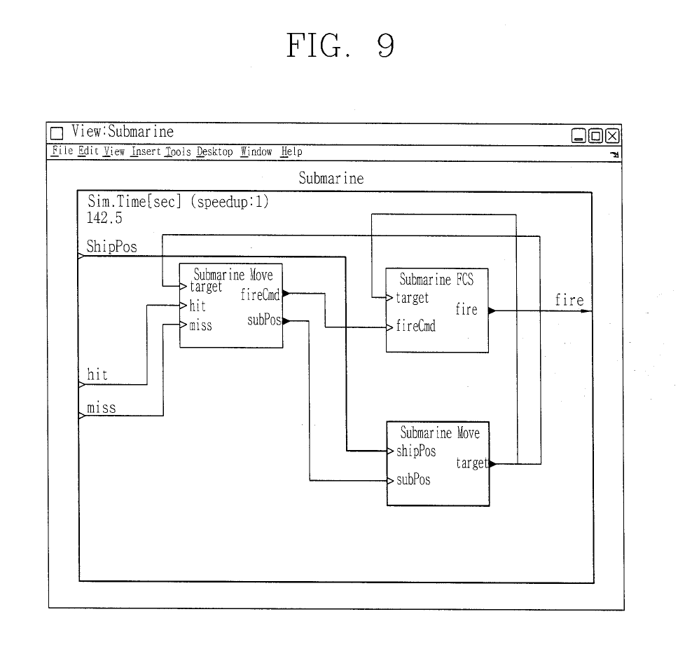

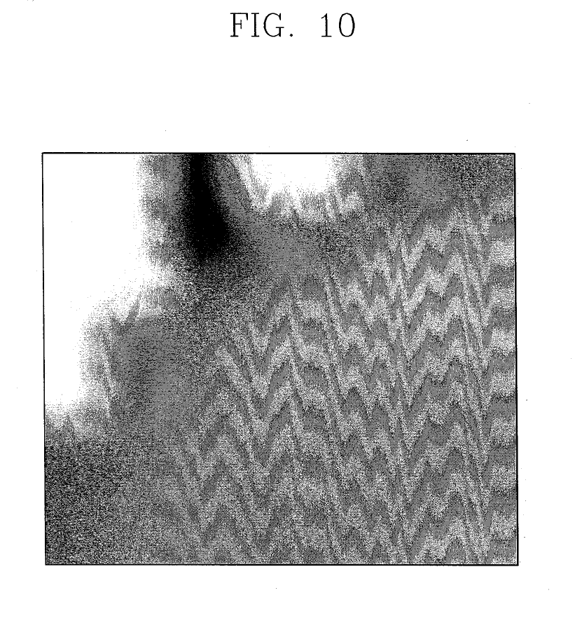

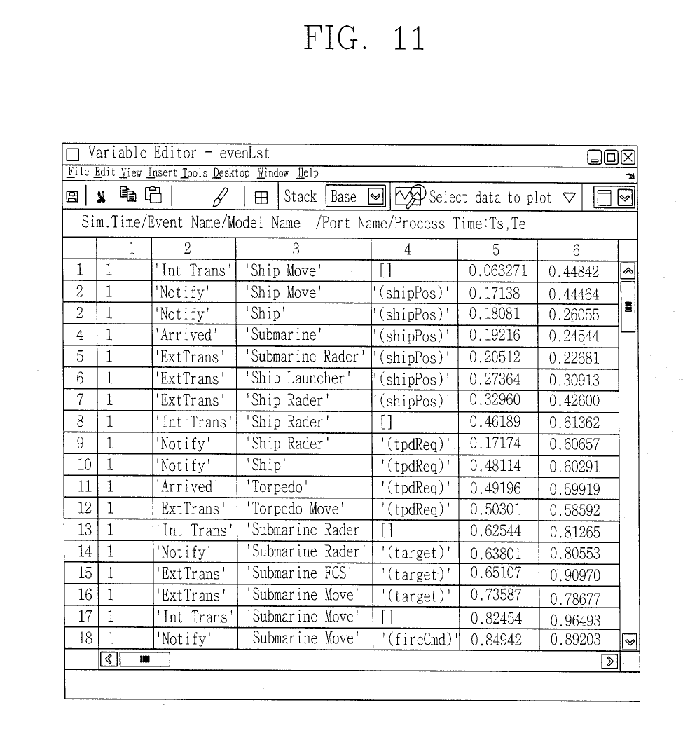

FIG. 8 is a conceptual view showing a model structure visualization function after the present invention is applied thereto, FIG. 9 is a conceptual view showing a coupling relation of models and a simulation visualization function after the present invention is applied thereto, and FIG. 10 is a conceptual view showing a function to visualize a schedule with respect to run time events of model objects, after the present invention is applied thereto.

A newly developed framework with a simple structure, provides a high performance to visualize and analyze a simulation model and an enhanced computing capability using parallel computing. Through the model structure visualizing function provided from the developed framework, a model structure can be extracted from an implemented application program. Therefore, the newly developed framework provides a means to compare a model structure obtained from an implementation step, with that obtained from a programming step.

Besides, event timings of objects generated while a simulation is being executed, and message propagation processes are visualized, so that orders to call models and simulation processes can be recognized in an intuitional manner.

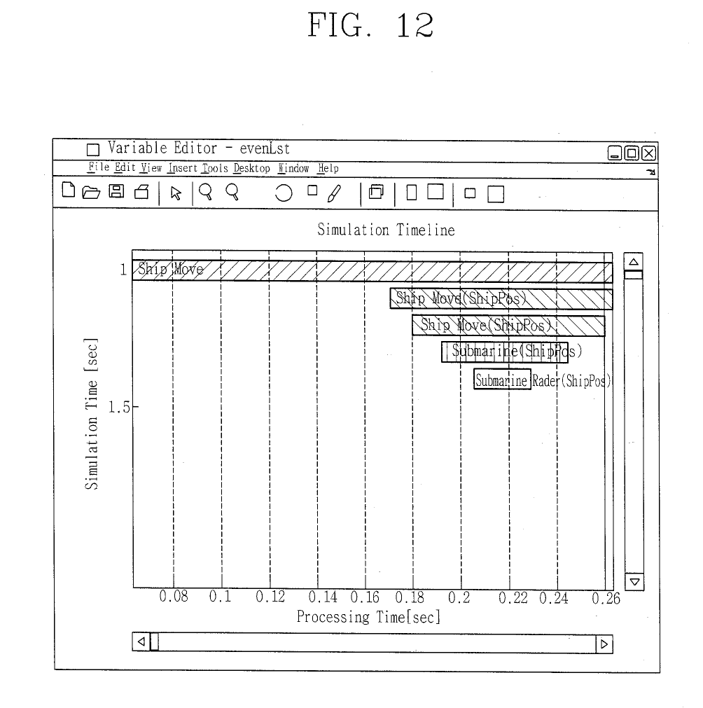

FIG. 11 is a conceptual view showing a simulation log analysis function, and FIG. 12 is a conceptual view showing a simulation log visualization function.

A framework developed to have the above model analysis function, provides a post simulation analysis function through simulation logging. Unlike the existing ASCII file logging method, a logging method of the new framework is implemented to make a log file in a matrix type of Matlap. As logs are recorded to be analyzed in a memory space of Matlap in the present invention, lowering of performance can be more minimized than in the existing ASCII file logging method.

Furthermore, in the framework configured to analyze logs more effectively and to solve problems occurring while models are being developed, logs are displayed in the form of a chart so that a processing time with respect to a simulation time can be recognized in an intuitional manner. This enables profiling with respect to performance of an implemented function.

The foregoing embodiments and advantages are merely exemplary and are not to be considered as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds are therefore intended to be embraced by the appended claims.

What is claimed is:

1. A method of simulating a discrete event comprising a plurality of models and a root coordinator, the method comprising:
the root coordinator's managing time schedules of the models;
the root coordinator's calling a model function based on the time schedules; and
the models' transmitting external input events to each other when the model function is called, based on a coupling structure of the models,
wherein when the plurality of models transmit the external input events to each other, the external input events are transmitted as an input parameter of the model function.

2. The method of claim 1, wherein the step of the root coordinator's managing time schedules of the models comprises:
the root coordinator's collecting time schedules of the plurality of models; and
the root coordinator's setting a minimum value of the collected time schedules, as a next time schedule.

3. The method of claim 2, wherein the plurality of models comprise atomic models and coupled models.

4. The method of claim 3, wherein the root coordinator is a single simulator with respect to the atomic models and the coupled models.

5. The method of claim 4, further comprising implementing a structure of the coupled models, as a composite pattern.

6. The method of claim 2, further comprising directly transmitting messages among the plurality of models.
